(19) United States
(12) Patent Application Publication
(10) Pub. No.: US 2024/0030516 A1
(43) Pub. Date: Jan. 25, 2024

(54) Cell Arrangement, Energy Store, and Method for Producing a Cell Arrangement

(71) Applicant: Bayerische Motoren Werke Aktiengesellschaft, (US)

(72) Inventor: Christian RAUBITSCHEK, Muenchen (DE)

(21) Appl. No.: 18/026,487

(22) PCT Filed: Oct. 4, 2021
(86) PCT No.: PCT/EP2021/077216

§ 371 Date: Mar. 15, 2023

(30) Foreign Application Priority Data
Oct. 21, 2020 (DE) 10 2020 127 734.2

(51) Int. Cl. H01M 10/6556; H01M 10/48; H01M 10/653; H01M 10/643; H01M 10/613; H01M 10/04

(52) U.S. Cl. CPC H01M 10/6556; H01M 10/486; H01M 10/653; H01M 10/643; H01M 10/613; H01M 10/0422; H01M 10/488

(57) ABSTRACT

A cell arrangement, in particular a cell module, includes a plurality of energy storage cells, the cell housings of the energy storage cells having markings, and the energy storage cells being oriented or positioned according to the markings.

### BACKGROUND AND SUMMARY

The present invention relates a cell arrangement comprising a multiplicity of energy storage cells, in particular a cell module, an energy store, and a method for producing the cell arrangement.

Cell arrangements or cell modules of the type under discussion consist of a multiplicity of energy storage cells. A plurality of such cell modules is often combined and forms an energy store, in particular a high-voltage store, such as are used as traction batteries in electrified or fully electric vehicles. These are extremely complex units, not only as far as the manufacture is concerned but also in respect of the operational response. In particular, the heat development of the energy storage cells during operation represents a considerable challenge.

It is therefore an object of the present invention to provide a cell arrangement, an energy store and a method for producing a cell arrangement which optimize the operational response without at the same time increasing costs.

This object is achieved by a cell arrangement, by an energy store, and by a method in accordance with the independent claims. Further advantages and features can be gleaned from the dependent claims as well as the description and the attached figures.

In accordance with the invention, a cell arrangement, in particular a cell module, comprises a multiplicity of energy storage cells, wherein the cell housings of the energy storage cells have markings, and wherein the energy storage cells are aligned or positioned corresponding to the markings. Advantageously, the arrangement of the energy storage cells therefore does not take place undirected or randomly but rather according to a preset scheme, wherein this scheme has been or is preset by the markings. The energy storage cells are, for example, lithium-ion cells or lithium-sulfur cells. Advantageously, the basic concept of the invention is, however, not restricted to a specific cell type or a specific cell chemistry.

In accordance with one preferred embodiment, the markings indicate the temperature response of the respective energy store cell. In accordance with one embodiment, the markings indicate, for example, a region or a point at which the respective energy store cell has a certain temperature during operation, for example a minimum or else a maximum temperature. In accordance with a preferred embodiment, the markings identify the respective temperature hotspot of the energy store cell. Energy storage cells of the type under discussion, in particular for high-voltage batteries, for example lithium-ion (rechargeable) batteries, have thermal hotspots, i.e. regions at which the cells are at their maximum level of heat during operation. These hotspots are caused, for example, by inner electrical diverters from anode/cathode to the cell terminals or possibly also by other mechanical or electrochemical properties of the cell. The energy storage cells must only be operated up to specific operational and safety temperature limits. The hotter the hottest point on the cell is, the lower the permissible current and power of the cell are. The hottest point on the cell therefore limits the operation. Hot points likewise result in locally increased cell aging up to damage to the cell or cell chemistry. Expediently, these regions of the energy storage cells can be made visible by means of the markings.

Preferably, the markings are applied to or on the cell housings on the outside. The markings can be designed to be visible and/or also at least identifiable by a machine. There is a wide variety of possibilities for applying or attaching the markings. Depending on the configuration of the cell housing, the marking or markings can also be introduced mechanically, for example by embossing, lasering, etc. Alternatively, colors can also be used.

In accordance with one preferred embodiment, the cell arrangement comprises a heat transfer element, which is designed to adjust the temperature of the cell arrangement, and wherein the markings are oriented towards the heat transfer element. Expediently, an optimum temperature adjustment, in particular cooling, can be achieved by the energy storage cells aligned corresponding to the marking since in particular the hottest points on the energy storage cells are oriented towards the heat transfer element. This has significant advantages over a random orientation of the energy storage cells in which there is a high degree of probability that the critical, in terms of the temperatures occurring, regions or sections of the energy storage cells are not cooled at all.

In accordance with one preferred embodiment, the markings or the regions of the energy storage cells to which the markings are applied make immediate or direct contact with the heat transfer element. In particular, the heat transfer element comprises a cooling face which makes direct or immediate contact with the energy storage cells or the cell housings thereof.

In accordance with one preferred embodiment, the heat transfer elements make contact with the energy store cell on one side. By virtue of the targeted arrangement of the energy storage cells, an optimum cooling effect is achieved despite the only one-sided arrangement.

In accordance with one embodiment, the heat transfer element has or can have a fluid flowing through it for heat transfer. Preferably, the heat transfer element is provided for cooling. In addition or as an alternative, the heat transfer element can also be used for heating or warming the cell module. Advantageously, the form and position of the heat transfer element preset an alignment and positioning of the energy storage cells.

In accordance with one preferred embodiment, the cell housings are solid cell housings. Such solid cell housings can be in the form of prismatic cell housings, for example.

In accordance with one preferred embodiment, the cell housings are round cell housings, wherein the markings are arranged on the lateral or circumferential faces of the round cell housings. In accordance with one preferred embodiment, the cell module is a round cell module with side cooling. The heat transfer element is in this case expediently designed as a cooling coil which touches the energy storage cells on one side. Alternatively, the energy storage cells can also be in contact with a cooling coil on two sides. It is crucial that the round cells can advantageously be oriented on the basis of the markings in such a way that the hottest point, in particular, therefore, the marked point on the cell housing, is aligned directly or immediately towards the cooling face of the cooling coil or of the cooling element or of the heat transfer element or makes contact therewith.

In accordance with an alternative embodiment, the cell housings are soft cell housings, in particular, for example, so-called softpacks. The basic concept of the invention is applicable to any cell type and is not restricted to a specific housing shape or to a predetermined cell chemistry.

According to the invention, an energy store, in particular a high-voltage store, comprises at least one cell arrangement according to the invention. In accordance with one preferred embodiment, the cell arrangement comprises a multiplicity of energy storage cells, wherein the energy storage cells are in the form of lithium-ion cells or lithium-sulfur cells.

Further, the invention relates to a method for producing a cell arrangement, comprising a multiplicity of energy storage cells, comprising the following steps:
providing a multiplicity of energy storage cells;
applying markings to the cell housings of the energy storage cells;
arranging or aligning the energy storage cells corresponding to the markings during construction of the cell arrangement.

Preferably, the energy storage cells are so-called round cells. Each of the energy storage cells is expediently provided with a, preferably precisely one, marking, which identifies a temperature response of the respective energy store cell during operation. In particular, the marking indicates in each case the temperature hotspot of the respective energy store cell. Advantageously, the energy storage cells can now be aligned exactly corresponding to their markings such that the hottest points of the energy storage cells or the cell housings are cooled optimally. This is achieved by virtue of the fact that in particular these points are brought into direct or immediate contact with the respective cooling element of the cell module.

Expediently, the cell arrangement comprises a heat transfer element, wherein the markings indicate the respective temperature hotspot of the energy storage cells. Preferably, the method comprises the following step:
arranging the cell housings in such a way that the cell housings are oriented towards the heat transfer element and/or bear directly against the heat transfer element.

In accordance with one embodiment, the method comprises the following step:
determining or detecting the temperature hotspots by way of simulation.

Preferably, the method generally comprises the step of determining or detecting the temperature or operational response of the energy store cell by means of simulation. Thus, it is possible to determine the point or position at which the marking needs to be applied. Alternatively, the arrangement of the respective marking is determined on the basis of the cell construction, wherein in this case empirical values can be used correspondingly.

In accordance with one embodiment, the method comprises the following steps:
detecting or identifying the marking or markings by way of a machine;
arranging and positioning the cell housings or the energy storage cells by way of a machine.

Advantageously, the identification and the arrangement and alignment of the cell housings can be performed in automated fashion and using a machine, for example using an industrial robot. Alternatively, the abovementioned method steps can also be performed by hand.

Advantageously, in this case both in the case of manual and in the case of automated positioning and orientation of the energy storage cells the hotspots can be assigned directly to a cooling face. The local heat can as a result advantageously be dissipated directly. The cell remains cooler at this point. The hotspots are reduced or completely eliminated. The cell has overall a more homogeneous temperature during operation and therefore uniform and non-local aging. Low temperatures in the affected regions extend the life of the cells. In some cases cell temperatures and temperature spreads of cells during operation are calculated in software models in the battery management system and highest temperatures are determined on the basis of a temperature model. Even if, for example, hottest points on the side of a cell are often not measured directly in the module because the temperature sensors are applied, for example, to the terminals at the top or at the bottom on the cell, the hottest point needs to be taken into consideration during operation by means of modelling or an offset. In this case, too, the present concept can reduce the complexity for a model or reduce the required temperature offset in the temperature detection and evaluation.

Further advantages and features can be gleaned from the description below of an embodiment of a cell arrangement with reference to the attached figures.

### BRIEF DESCRIPTION OF THE DRAWINGS

FIG. 1 shows a cell arrangement with randomly arranged energy storage cells; and

FIG. 2 shows an embodiment of a cell arrangement according to an embodiment of the invention.

### DETAILED DESCRIPTION OF THE DRAWINGS

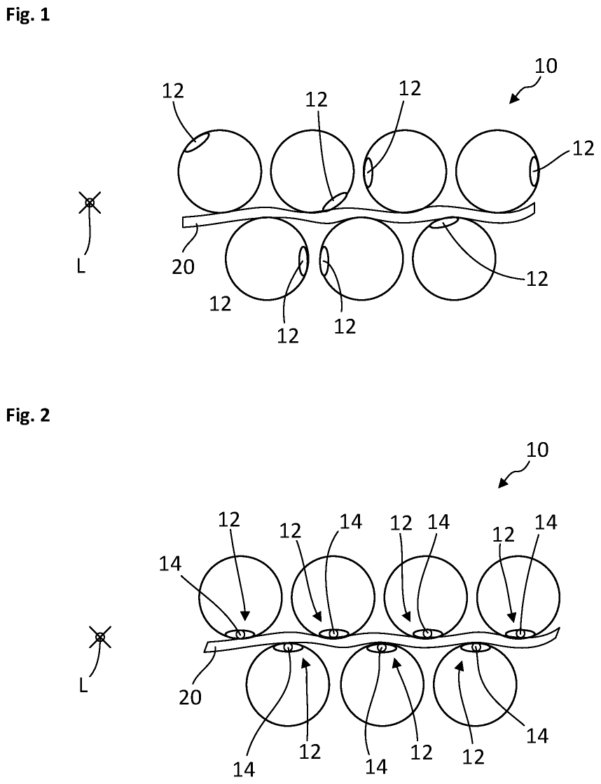

FIG. 1 shows, in a schematic view, taken along a longitudinal axis L, a cell arrangement, comprising a multiplicity of energy storage cells, wherein the cell housings 10 thereof are in the form of round cells. The lateral or circumferential faces of the cell housings extend along the longitudinal axis L. The cell housings 10 of the energy storage cells have temperature hotspots 12. A heat transfer element is sketched schematically and denoted by the reference symbol 20. It can be seen that the temperature hotspots 12 cannot be cooled ideally by the random arrangement of the energy storage cells or the cell housings 10.

FIG. 2 shows an embodiment of a cell arrangement according to the invention. The essential technical features are already known from FIG. 1. It is crucial here that the cell housings 10 are in this case provided with markings 14, in this case schematically in the form of circles, which indicate the temperature hotspots 12 of the cell housings 10 or the energy storage cells. As a result, it is possible to align or position the cell housings 10 in such a way that contact is made as directly as possible with a heat transfer element 20. In particular, the cooling faces of the heat transfer element 20 therefore bear directly against the regions of the cell housings 10 which have or would have the highest temperatures during operation.

### LIST OF REFERENCE SYMBOLS

10 cell housing
12 temperature hotspot
14 marking
20 heat transfer element
L longitudinal axis

1.-13. (canceled)

14. A cell arrangement, comprising:
a multiplicity of energy storage cells, each having a cell housing, wherein
the cell housings of the energy storage cells have markings, and
the energy storage cells are aligned or positioned corresponding to the markings.

15. The cell arrangement according to claim 14, wherein
the cell arrangement forms a cell module.

16. The cell arrangement according to claim 14, wherein
the markings indicate a temperature response of the energy storage cells.

17. The cell arrangement according to claim 16, wherein
the markings indicate a respective temperature hotspot of the energy storage cells.

18. The cell arrangement according to claim 14, further comprising:
a heat transfer element, which is designed to adjust a temperature of the cell arrangement, and
wherein the markings are oriented towards the heat transfer element.

19. The cell arrangement according to claim 18, wherein
the markings make direct contact with the heat transfer element.

20. The cell arrangement according to claim 18, wherein
the energy storage cells make contact on one side with the heat transfer element.

21. The cell arrangement according to claim 18, wherein
the heat transfer element comprises a fluid that flows through the heat transfer element.

22. The cell arrangement according to claim 14, wherein
the cell housings are solid cell housings.

23. The cell arrangement according to claim 14, wherein
the cell housings are round cell housings, and
the markings are arranged on circumferential faces of the round cell housings.

24. An energy store comprising at least one cell arrangement according to claim 14.

25. The energy store according to claim 24, wherein the energy store is a high-voltage store.

26. A method for producing a cell arrangement, comprising:
providing a multiplicity of energy storage cells;
applying markings to cell housings of the energy storage cells; and
arranging or aligning the energy storage cells corresponding to the markings during construction of the cell arrangement.

27. The method according to claim 26, further comprising:
providing a heat transfer element; and
arranging the cell housings such that the cell housings are oriented towards the heat transfer element and/or bear directly against the heat transfer element, wherein the markings indicate a respective temperature hotspot of the energy storage cell.

28. The method according to claim 27, further comprising:
determining the temperature hotspots by way of simulation.

29. The method according to claim 25, further comprising:
detecting or identifying the markings by way of a machine; and
arranging and positioning the cell housings by way of a machine.
